(19) United States
(12) Patent Application Publication
(10) Pub. No.: US 2008/0259835 A1
(43) Pub. Date: Oct. 23, 2008

(54) Locating content in broadband wireless access networks

(76) Inventors: Muthaiah Venkatachalam, Beaverton, OR (US); Kamran Etemad, Potomac, MD (US)

Correspondence Address: TROP PRUNER & HU, PC, 1616 S. VOSS ROAD, SUITE 750, HOUSTON, TX, 77057-2631, US

(21) Appl. No.: 11/788,606

(22) Filed: Apr. 20, 2007

(51) Int. Cl. H04L 12/18

(52) U.S. Cl. 370/311; 370/390; 455/574

(57) ABSTRACT

In some embodiments, only one multicast connection identifier is used in a WiMAX network per zone. This may result in power savings because it is not necessary for the mobile station to query a base station to obtain the correct information about how to locate desired channels in a WiMAX multicast. Instead, the mobile station may be maintained in a lower power consumption mode in which it need not transmit, but only receives information. This is because the mobile station has all the information it needs about what channels are available and can simply tune using a logical media channel identifier to the appropriate channel to receive the desired content without having to transmit a message to the base station to identify the correct channel.

### BACKGROUND

This relates generally to broadband wireless access networks.

Broadband wireless access networks may be used for transmitting programming content currently provided by television broadcasts and the Internet. A standard for such distributions has been propounded. See IEEE 802.16 IEEE Standards for Information Technology—Telecommunications and Information Exchange Between Systems—Metropolitan Area Networks—Specific Requirements, Part 16, Air Interface for Fixed Broadband Wireless Access Systems, IEEE New York, N.Y., May, 2005 (“WiMAX Standard”).

In a fixed broadband wireless access system, commonly called WiMAX (Worldwide Interoperability for Microwave Accessor), a base station may provide content to one or more mobile stations. The mobile stations may move from area to area and may, therefore, wirelessly communicate with different base stations in each area.

In order to receive the desired content, a system for identifying a particular channel is necessary. Conventionally, WiMAX may provide many content channels. One identifier is called the medium access control multicast connection identifier or MCID. The MCID identifies a connection to a medium access control layer on the base station to allow a mobile station to receive particular content. The number of connection identifiers available in conventional systems is somewhat limited because of the amount of bandwidth that may be consumed by using extremely large fields for such data. Conventionally, in the WiMAX standard identified above, 16 bits are available to provide 65,536 connection identifiers, including both unicast connection identifiers and MCIDs.

In order to increase the scalability of the system, logical channel identifiers may also be utilized. Thus, a number of different channels, such as 256 channels, may be identified by logical channel identifiers.

Thus, in conventional WiMAX distribution systems, content in the form of video programs and Internet-like content may be distributed over airwaves to mobile subscribers that move from area to area while continuing to receive the desired content. The mobile station may use various identifiers to identify which content it wishes to receive.

### BRIEF DESCRIPTION OF THE DRAWINGS

FIG. 1 illustrates a broadband wireless access network in accordance with some embodiments of the present invention;

FIG. 2 is a call flow for one scenario in accordance with one embodiment of the present invention; and

FIG. 3 is a call flow for another scenario in accordance with one embodiment of the present invention.

### DETAILED DESCRIPTION

In order to multicast content from content providers to mobile stations, a single multicast connection identifier (MCID) may be used for each multicast broadcast service zone. This content identifier may identify a medium access control (MAC) layer connection that may be accessed to receive content. However, the ability to select from among a wide variety of different content offerings may be facilitated by using logical media channel identifiers. The logical media channel identifiers, in one embodiment, may be provided by the core network, such as a core service network (CSN) in one embodiment, while the single multicast connection identifier or MCID may be provided in one embodiment by an access network such as an access service network (ASN). In this way, the logical media channel identifiers are provided from a source that knows what channels are available, while the connection identifier is provided from a source which is as close as possible to the actual air interface. This allocation scheme may reduce the amount of signaling traffic on the air interface. Moreover, by only having one multicast connection identifier per zone, mobile station power consumption may be reduced, in some embodiments, because it would no longer be necessary for the mobile stations that are listening to broadcast/multicast transmissions in idle mode, to transmit a query to obtain the correct connection identifiers. Initially, the multicast connection identifiers, in the form of logical media channel identifiers, may be provided to the mobile stations which then do not need to clutter the air interface with requests for information about the connection identifiers. The mobile stations may enter low power consumption mode, called an idle mode, where they only receive information (and do not transmit). Since the mobile stations already have all the logical channel identifiers, they need not exit the idle mode to contact the base station in order to obtain identifiers, as would be the case with multicast connection identifiers. Thus, the mobile stations may maintain themselves in the lower power consumption mode, without the need to transmit to query for the appropriate identifiers.

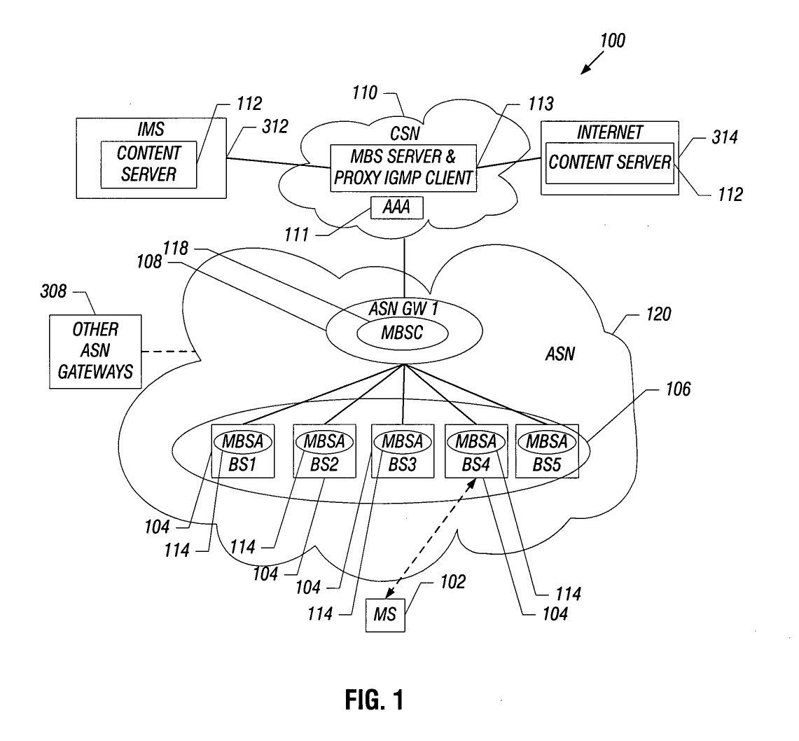

FIG. 1 illustrates a broadband wireless access network in accordance with some embodiments of the present invention. Wireless access network 100 comprises a core network, such as a core service network (CSN) 110, and an access network, such as an access service network (ASN) 120. The ASN includes the complete set of network functions needed to provide radio access to a WiMAX subscriber, constitutes the network to which a mobile station (MS) attaches and includes the base stations (BSs) and access router (not shown). The CSN provides connectivity to the Internet and provides policy functions or authentication, authorization, and accounting services.

Among other things, wireless access network 100 may receive content from one or more content servers 112 and may provide the content to one or more mobile stations (MS) 102. ASN 120 may include one or more gateways (GW) 108 and a plurality of base stations (BS) 104, illustrated as BS1 through BS9. CSN 110 may include a policy function (PF) or authentication authorization accounting (AAA) (PF/AAA) server 111 which, among other things, may handle requests for access. AAA server 111 of CSN 110 may include a policy function (PF) to authorize mobile stations 102 to receive multicast broadcast services.

In accordance with embodiments, gateways 108 may include a multicast broadcast service controller (MBSC) 118. The MBSC 118 may create one or more multicast broadcast service (MBS) zones 106, and each MBS zone 106 may comprise a plurality of base stations 104. MBSCs 118 may create MBS zones 106 by establishing specific time and frequency parameters for simultaneous multicast downlink transmissions to mobile stations 102 within a particular MBS zone 106. In these embodiments, base stations 104 may include MBS agents (MBSA) 114 to cause and/or instruct base stations 104 to synchronously transmit identical content within MBS regions of downlink subframes. The identical MBS regions may include multicast broadcast content identified by multicast connection identifiers (CIDs). The CSN 110 may also include MBS server and proxy first hop Internet Group Management Protocol (IGMP) client 113. See Internet Group Management Protocol, Version 3, Network Working Group, Request for Comments 3376, October, 2002.

In some embodiments, CSN 110 may also include a session description protocol (SDP) proxy. In these embodiments, mobile station 102 may use primitives of the SDP to contact the SDP proxy and browse the current contents of a multicast session directory within CSN 110, although the scope of the invention is not limited in this respect.

In some embodiments, wireless access network 100 may operate as a single-frequency network (SFN). In these embodiments, base stations 104 of a common MBS zone 106 may have their downlink and/or uplink subframes synchronized in both time and frequency, allowing mobile stations 102 to receive multicast broadcast content from any base station 104 of a particular MBS zone 106 without having to perform handover operations within an MBS zone. In these embodiments, mobile stations 102 may take advantage of diversity gain achieved by receiving signals concurrently from more than one base station 104 of an MBS zone 106, which may result in an improved signal-to-noise ratio (SNR) at the mobile station 102. In these embodiments, multicast broadcast content may be provided within identical MBS regions of downlink subframes, allowing mobile stations 102 to receive broadcast content from any one or more of base stations 104 of an MBS zone 106.

In some alternate embodiments, one or more non single-frequency network (non-SFN) base stations (not illustrated) outside MBS zone 106 may transmit the multicast data non-synchronously, although the scope of the invention is not limited in this respect. In these embodiments, each base station 104 may operate independently.

MBSC 118 may be a stand-alone entity within the ASN. In accordance with embodiments, MBSC 118 may perform aggregations, transmissions, scheduling and synchronizations for broadcasting data in MBS zones 106 it controls. MBSC 118 may also create MBS zones, delete MBS zones, and modify properties of existing MBS zones.

As illustrated in FIG. 1, MBSAs 114 reside in base stations 104. MBSAs 114 may transmit MBS content over air interface 330 in a synchronized fashion to mobile stations 102 as discussed above, and may assist MBSC 118 in management and control operations.

Content servers 112 may provide broadcast content and may reside in CSN 110, Internet Protocol (IP) multimedia subsystem (IMS) network 312 and/or Internet 314. The broadcast content may include, for example, music and/or video streaming, although the scope of the invention is not limited in this respect. In some embodiments, content servers 112 may feed MBS content to MBS server and proxy IGMP client 113, which may serve as a focal point for further downlink transmissions within a wireless access network, such as wireless access network 100 (FIG. 1). In some embodiments, MBSC 118 may coordinate with MBSAs 114 of MBS zone 106 to ensure time and frequency synchronization of multicast broadcast content within MBS zone 106.

In some embodiments, several content servers 112 may feed multiple broadcast channels into a single MBS zone. In these embodiments, MBS server 113 may aggregate the content in a timely manner and feed the aggregated content to ASN gateway 108. As illustrated in FIG. 1, ASN gateway 108 may interface with other ASN gateways, such as ASN gateways 308.

In some embodiments, an MBSC may be located within CSN 110, rather than within ASN 120 (FIG. 1). In these embodiments, the MBSC within CSN 110 may control a larger MBS zone, such as a large nationwide zone for national TV programming. In this way, it may be more scaleable and efficient to have an MBSC in a core service network portion of the operators network.

The proxy IGMP framework 113 provides all the benefits of IGMP without really requiring IGMP at the user device. Generally, IGMP tells multiple users how to sign up for a multicast session. The proxy IGMP framework 113 can work for all classes of device, including those set of devices that do not natively have an IGMP stack. Error link resources may not be needed for IGMP signaling in some embodiments. The proxy IGMP framework 113 works for both SFN and non-SFN operation modes without much change.

The multi BS MBS allows the MS to browse the current multicast session with listings stored on the MBS server in the CSN. For SFN, the session directory contains preconfigured MBS listings from the operator. The MS can be made aware of the IP address and/or the universal resource identifier (URI) of the MBS server 113 either during the provisioning phase or sign on phase. The MS may use a simple interface, like HTTP, to access the MBS server and then browse the directory listings. Upon browsing the directory server, the MS may wish to join any of the currently on multicast sessions. The MS indicates to the MBS server the session it wishes to join.

An MS can leave a multicast session by explicitly signaling to the BS that it is terminating its MBS session or powering down using medium access control messages. The BS can also initiate the cleanup of resources. Alternatively, the MS connects to the MBS server and indicates a preference to switch to some other MBS channel. The MBS server can then initiate the cleanup of resources.

In a single BS MBS, the MS is not expected to be IGMP compliant. The proxy IGMP client situated in the CSN acts as the IGMP client on behalf of the MS. The multicast source can be anywhere in the Internet or the operator's network. The MBS server 113 acts as the session directory in the WiMAX CSN. For IP multicast scenarios, the MBS server may listen to the Internet multicast announcements on the multicast announce channel or may have preconfigured MBS listings from the operator. The MBS server caches information about the currently on multicast sessions in the Internet or in the operator's network, their owners, their durations, their start times, etc.

Referring to FIG. 1, in some embodiments, wireless access network 100 may use IP multicast techniques as part of its SFN operations. In these embodiments, MBSC 118 may be part of an IP multicast group and may receive broadcast content from the IP multicast group.

In some embodiments, IP multicast may be used within MBS zone 106. In these embodiments, for each MBS zone 106, MBSC 118 may set up a local IP multicast group to transmit the multicast broadcast content. In these embodiments, MBSC 118 may provide the multicast IP address for the MBS zone 106 to MBSAs 114 using the MBS primitives described below. These MBS primitives may include requests (REQs), responses (RSPs) and confirms (CNF).

Some examples of MBS primitives include: MBS-join-REQ, which may be sent from an MBSC to an MBSA; MBS-join-RSP, which may be sent from an MBSA to an MBSC; MBS-join-CNF, which may be sent from an MBSC to an MBSA; MBS-leave-REQ, which may be sent from an MBSA to an MBSC; MBS-leave-RSP, which may be sent from an MBSC to an MBSA; MBS-modify-REQ, which may be sent from an MBSC to an MBSA and vice versa; and MBS-modify-RSP, which may be sent from an MBSC to an MBSA and vice versa.

MBS operations performed by MBSC 118 for an MBS control path may include MBS zone creation, deletion, and/or modification. In addition, as part of the MBS operations, an MBSA may join an MBS zone when a mobile station joins, and an MBSA may leave an MBS zone when a mobile station leaves.

Referring to FIG. 1, in some embodiments, base stations 104 and mobile stations 102 may communicate orthogonal frequency division multiplexed (OFDM) communication signals over a multicarrier communication channel. The multicarrier communication channel may be within a predetermined frequency spectrum and may comprise a plurality of orthogonal subcarriers. In some embodiments, the multicarrier signals may be defined by closely spaced OFDM subcarriers. In some wireless access network embodiments, base stations 104 and mobile stations 102 may communicate in accordance with a multiple access technique, such as OFDM, although the scope of the invention is not limited in this respect. In some embodiments, wireless access network 100 may comprise a broadband wireless access (BWA) network, such as a Worldwide Interoperability for Microwave Access (WiMax) network, although the scope of the invention is not limited in this respect.

In some embodiments, mobile stations 102 may be part of a portable wireless communication device, such as a personal digital assistant (PDA), a laptop or portable computer with wireless communication capability, a web tablet, a wireless telephone, a wireless headset, a pager, an instant messaging device, a digital camera, an access point, a television, a medical device (e.g., a heart rate monitor, a blood pressure monitor, etc.), or other device that may receive and/or transmit information wirelessly.

In some embodiments, the frequency spectrums for the communication signals between base stations 104 and mobile stations 102 may comprise frequencies between 2 and 11 GHz, although the scope of the invention is not limited in this respect.

A multicast connection identifier (MCID) uniquely identifies a connection to a medium access control (MAC) layer. The allocation of MCIDs may happen either from the ASN or CSN. The MCIDs may be allocated and pushed to the MS from the MBS server 113 in the CSN 110 in one embodiment. In another embodiment, MCIDs may be allocated by the MBS controller 118 and pushed to the MS through the MBS server. In still another embodiment, MCIDs may be allocated and pushed to the MS directly from the MBS controller 118.

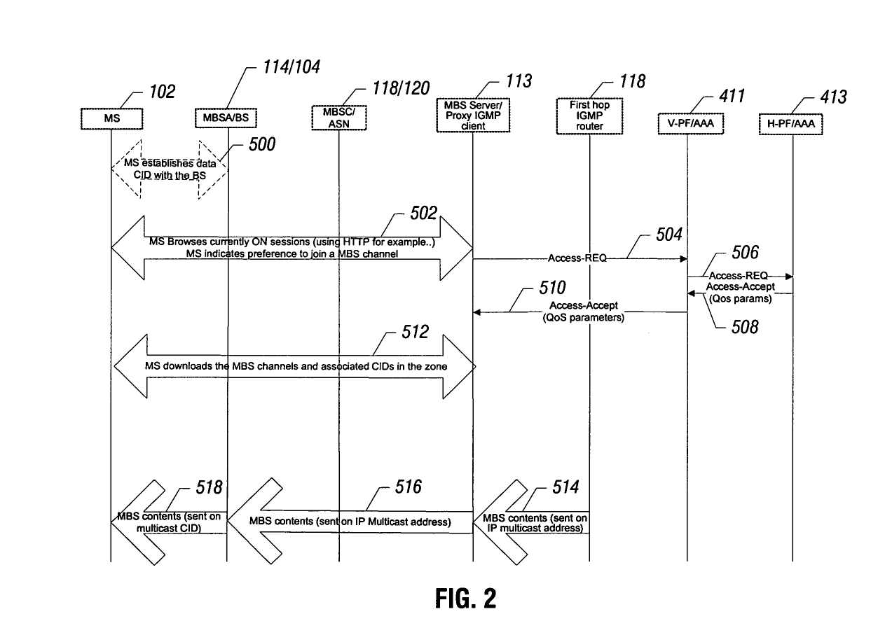

Starting with the situation where the MCIDs are allocated and pushed to the MS from the MBS server 113 in CSN 110, referring to FIG. 2, the MCIDs are sent to the MS 102 from the MBS server 113 at 512 as part of a hypertext transfer of protocol (HTTP) session between the MS and the MBS server 113.

The MS 102 establishes a data MCID with the BS 104 at 500. The MS browses currently “on” sessions, for example, using hypertext transfer protocol, and indicates its preference to join an MBS channel at 502. An access request 504 occurs between the MBS server/proxy IGMP client 113 and the visitor-policy function/authentication, authorization, accounting server (V-PF/AAA) 411. A visitor PF/AAA is an AAA, used by an MS when traveling, that is different from a home-policy function (PF)/AAA, normally used by an MS. The request is forwarded at 506 to the home-policy function/authentication, authorization, accounting server (H-PF/AAA) 413.

Quality of service parameters and access accept are returned at 508 and at 510 to the MBS server 113. Then the MS downloads, at 512, the MBS channels and associated CIDs in the zone. Thus, in the first hop of the IGMP router 118, the MBS contents are sent to the server 113 on the IP multicast address as indicated at 514. Then the contents are sent on the IP multicast address at 516 to the MBS agent/base station, and, finally, the MBS contents are sent on the multicast CID to the MS as indicated at 518.

In the second scenario, where the MCIDs are allocated by the MBS controller and pushed to the MS through the MBS server, again, referring to FIG. 2, the MCIDs are sent to the MS from the MBS server at 512 as part of the hypertext transfer protocol session ensuing between the MS and the MBS server. However, the MBS controller 118 does the MCID allocation and passes the allocated CIDs to the MBS server right after the MCIDs are allocated. Once the MCIDs are received by the MBS server, the MBS server stores them and passes them on to the MS. The MBS controller 118 may update the MCID allocations in the MBS server periodically or only on changes.

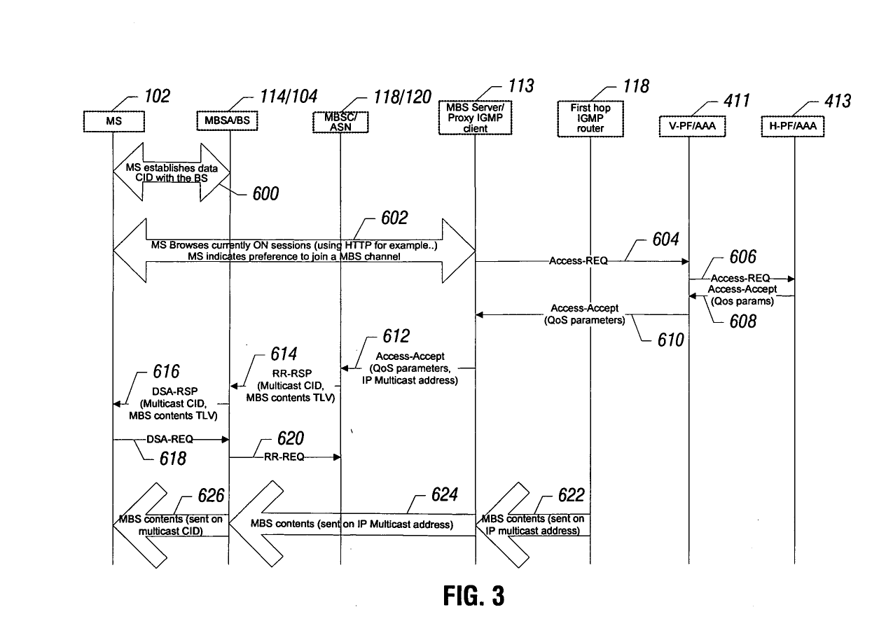

Finally, in the third case where MCIDs are allocated and pushed to the MS directly from the MBS controller, the flow is shown in FIG. 3. The MS establishes a data MCID with the BS at 600. The MS browses currently “on” sessions and indicates its channel preference at 602. An access request 604 is forwarded from the MBS server 113 to the V-PF/AAA 411. The V-PF/AAA 413 forwards the request to the H-PF/AAA 413. The access accept and QOS parameters 608 are returned to the V-PF/AAA 411 and then passed at 610 via the MBS server 113 to the MBS controller 118 or ASN 120 at 612. The MCIDs are allocated and sent to the MS from the MBS controller 118 using a medium access control message dynamic service addition request message (DSA-REQ) 618 and dynamic service addition response message (DSA-RSP) 616. The trigger for the MBS controller 118 sending the CID to the MS is from the “access-accept” 612 or a similar message from the MBS server 113 to the MBS controller 118, indicating that the user has been authenticated and authorized for MBS service. The MBS controller 118 sends a radio resource response 614 to the base station MBS agent 114.

The same process may be used for a static flat rate broadcast services to all subscribed users, as well as dynamic multicasting to a select group of users in a multicast group. Each multicast CID may include multiple MBS content identifier service type-length type values (TLVs) (each content ID TLV maps to a logical media channel ID, which is like a video channel or a TV channel, for example).

Since the MBS contents ID TLV is an application level characterization of the video/MBS stream, it is allocated by the MBS server. Once allocated by the MBS server, then, in the case where MCIDs are allocated and pushed to the MS from the MBS server or allocated by the MBS controller and meshed through the MBS server, the MBS server sends the MBS contents to the MS as part of step 502 in FIG. 2, along with the multicast CID. Where the MCID is allocated and pushed to the MS directly from the MBS controller, the MBS server sends the MBS contents TLV to the MBS controller either every time the TLV is newly created/changed or every time an MS joins for MBS service. The MBS controller, in turn, includes a downstream radio resource response (RR-RSP) message 614 to the base station which then includes the contents ID's TLVs on DSA-RSP message 616 to the MS, as shown in FIG. 3.

The MBS contents 622 may be sent on an IP multicast address at 622 to the MBS server 113. From the server, the contents are sent on the IP multicast address to the MBS agent 114 at 624. Finally, the contents reach the MS 102 on the multicast CID 626 from the base station 104.

The MS gets the MCIDs and content IDs TLVs which contain the IDs for the MBS logical media channels within the multicast CID. In the case of multiple BS MBS, each MBS zone is composed of multiple BSs that synchronize their transmission of the same content in time and in frequency. In such a scenario, the MS is able to move freely within the MBS zone and listen to the MBS transmissions, as well as switch MBS channels, both in idle mode and in non-idle mode, without interacting with the network in the uplengths.

In one embodiment, only one multicast CID may be used per MBS zone. This multicast CID and the associated MBS contents IDs TLVs that contain logical media channels within the multicast CID are made available to the MS when the MS joins to MBS transmission in the zone. Each logical media channel ID that is part of the MBS contents IDs may be 8 bits in length, in one embodiment, which means that a multicast CID can carry 256 MBS channels in the MBS zone. Since the MS has all the logical media channel IDs for the MBS zone, it can now easily switch channels irrespective of whether it is in an idle (low power consumption) or non-idle mode. Using the same multicast CID within a zone may also expedite the process of resynchronization of an MS with MBS transmission in a non-SFN network.

Some embodiments of the invention may be implemented in one or a combination of hardware, firmware and software. Some embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disk storage media, optical storage media, flash-memory devices, electrical, optical, acoustical or other form of propagated signals (e.g., carrier waves, infrared signals, digital signals, etc.), and others.

In the foregoing detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, invention may lie in less than all features of a single disclosed embodiment. Thus, the following claims are hereby incorporated into the detailed description, with each claim standing on its own as a separate preferred embodiment.

What is claimed is:

1. A method comprising:
enabling a mobile station in a broadband wireless access network to access a selected one of a plurality of content channels while said mobile station is in idle mode.

2. The method of claim 1 including allocating only one multicast connection identifier is provided to mobile stations per multicast broadcast service zone.

3. The method of claim 2 including allocating a multicast connection identifier from an access network.

4. The method of claim 3 including allocating said identifier from an access service network.

5. The method of claim 4 including allocating said identifier using a multicast broadcast service controller.

6. The method of claim 2 including allocating a multicast connection identifier from a core network.

7. The method of claim 6 including allocating a multicast connection identifier from a core service network.

8. The method of claim 7 including allocating a multicast connection identifier using a multicast broadcast service server.

9. The method of claim 2 including allocating logical channel identifiers from a core network.

10. The method of claim 9 including using content identifier service type-length type values as logical channel identifiers.

11. The method of claim 2 including using a proxy Internet Group Management Protocol client in a core service network to enable a mobile station to sign up for a multicast session.

12. A broadband wireless access network comprising:
a multicast broadcast service controller;
an access network gateway; and
said network to enable a mobile station to select one of a plurality of channels without making a transmission.

13. The network of claim 12, said controller to allocate only one multicast connection identifier to mobile stations per multicast broadcast service zone.

14. The network of claim 12 wherein said controller to enable said mobile station to select a channel while said station is in an idle mode.

15. The network of claim 13 wherein said network is an access service network.

16. A core network comprising:
a multicast broadcast service server;
an authentication, authorization, accounting server; and
said network to allocate logical channel identifiers.

17. The network of claim 16, said network to allocate multicast connection identifiers.

18. The network of claim 16, said network being a core service network.

19. The network of claim 16 including a proxy Internet Group Management Protocol client to enable mobile station to sign up for a multicast session.

20. A system comprising:
a core network including an authentication, authorization, accounting server;
an access network coupled to said core network, said access network including a multicast broadcast service controller; and
said system to enable mobile stations to select channels without the need to make a transmission.

21. The system of claim 20, said controller to allocate only one multicast connection identifier to mobile stations per multicast broadcast service zone.

22. The system of claim 20 wherein said controller to enable said mobile station to select a channel while said station is in an idle mode.

23. The system of claim 21 wherein said access network is an access service network.

24. The system of claim 20, said access network to allocate multicast connection identifiers.

25. The system of claim 20, said core network being a core service network.

26. The system of claim 20, said core network including a proxy Internet Group Management Protocol client to enable mobile station to sign up for a multicast session.
